(19) United States
(12) Patent Application Publication
(10) Pub. No.: US 2024/0190781 A1
(43) Pub. Date: Jun. 13, 2024

(54) PLATINUM SOLUTION FOR SILVER DECORATION AND USE THEREOF

(71) Applicant: NORITAKE CO., LIMITED, Nagoyo (JP)

(72) Inventors: Yoshihide Maeno, Miyoshi-Shi (JP); Yoshihiro Suzuki, Miyoshi-Shi (JP); Yukiko Kikugawa, Miyoshi-Shi (JP)

(21) Appl. No.: 18/284,591

(22) PCT Filed: Mar. 11, 2022
(86) PCT No.: PCT/JP2022/010785

§ 371 Date: Sep. 28, 2023

(30) Foreign Application Priority Data
Mar. 31, 2021 (JP) 2021-061387

(51) Int. Cl. C04B 41/51; A47G 19/02; C04B 41/00; C04B 41/45; C04B 41/88; C22C 5/04

(52) U.S. Cl. CPC C04B 41/5122; C04B 41/009; C04B 41/4535; C04B 41/88; C22C 5/04; A47G 19/02

(57) ABSTRACT

The present disclosure provides a technology that realizes a silver-colored decorative portion that does not spark when heated by a microwave oven, is lustrous, and has excellent coloration. A platinum solution disclosed herein is a platinum solution used for silver decoration of a ceramic substrate and includes at least Pt, Si, and Bi. In terms of a weight ratio where a total of a metal element included in the platinum solution and Si is 100 wt %, the platinum solution has a composition that includes 50 wt % to 99 wt % of Pt, 0 wt % to 25.5 wt % of a total of Au, Rh, Pd, and Ag (where a content of Rh is 0 wt % to 8.5 wt %), 11 wt % or less of Si, 10 wt % or less of Bi, 0 wt % to 5 wt % of Al, and 0 wt % to 15 wt % of other metal elements.

### BACKGROUND OF THE INVENTION

### Technical Field

The present invention relates to a platinum solution used for silver decoration. Specifically, the present invention relates to a silver-colored platinum solution including Pt and a ceramic product including a sintered body of the platinum solution. Note that the present application claims priority from Japanese Patent Application No. 2021−061387 filed on Mar. 31, 2021, the entire disclosure of which is incorporated by reference herein.

### Background Art

Some ceramic products represented by ceramic ware, glass, tiles, or the like are decorated with gold or silver decoration on surfaces thereof to give an impression of elegance or luxury. Among such ceramic products, there are products (for example, tableware or the like) that are expected to be heated by a microwave oven. Therefore, it is desirable that a decorative portion does not spark due to high-frequency electromagnetic waves (for example, a frequency of about 2.45 GHZ) emitted by a microwave oven. Examples of a technology that realizes such a decorative portion is disclosed in Patent Document 1 and Patent Document 2. For example, Patent Document 2 discloses a technology for a platinum decorative portion that does not spark even when the platinum decorative portion is exposed to high-frequency electromagnetic waves emitted from a microwave oven and has a delustered platinum color called matte platinum.

### CITATION LIST

### Patent Document

PATENT DOCUMENT 1: Japanese Patent Publication No. 2854813
PATENT DOCUMENT 2: Japanese Laid-open Patent Publication No. 2001

### SUMMARY OF THE INVENTION

Incidentally, it is desired to realize a silver-colored decorative portion that has gloss (luster) and excellent coloration as a decorative portion that does not spark when heated by a microwave oven. With such a decorative portion, a ceramic product that gives a more elegant or luxurious impression is realized.

In view of the above-described circumstances, the present invention has been devised and it is therefore a main object of the present invention to provide a platinum solution that realizes a silver-colored decorative portion that does not spark when heated by a microwave oven, is lustrous, and has excellent coloration. It is another object of the present invention to provide a ceramic product including a sintered body of the platinum solution.

To achieve the above-described objects, a platinum solution disclosed herein is a platinum solution used for silver decoration of a ceramic substrate, includes at least Pt, Si, and Bi, and, in terms of a weight ratio where a total of a metal element included in the platinum solution and Si is 100 wt %, the platinum solution has a composition that includes 50 wt % to 99 wt % of Pt, 0 wt % to 25.5 wt % of a total of Au, Rh, Pd, and Ag (where a content of Rh is 0 wt % to 8.5 wt %), 11 wt % or less of Si, 10 wt % or less of Bi, 0 wt % to 5 wt % of Al, and 0 wt % to 15 wt % of other metal elements.

According to the platinum solution, since a ratio of Pt is high, a silver-colored decorative portion that is lustrous and has excellent coloration can be realized. Moreover, the platinum solution includes Si and Bi that become glass components after firing, so that electrical conductivity of the sintered body is reduced and generation of sparks by heating by a microwave oven can be prevented.

In a preferred mode of the platinum solution disclosed herein, in terms of the weight ratio, a ratio of the total of Pt, Au, Rh, Pd, and Ag is 70 wt % or more and 99 wt % or less. According to the above-described configuration, a constitution ratio of the precious metal element is high, so that a silver-colored decorative portion that has even better coloration is realized.

In another preferred mode of the platinum solution disclosed herein, in terms of the weight ratio, Si>Bi. Thus, a softening point of a glass component is increased, so that, in the sintered body of the platinum solution, it can be suppressed that the glass component is unevenly distributed in a gravity direction. As a result, the glass component is likely to be arranged between precious metal particles and the electrical conductivity of the sintered body can be further reduced.

In another aspect, according to a technology disclosed herein, a ceramic product is provided. The ceramic product includes a sintered body of the platinum solution disclosed herein. The sintered body does not spark when heated by a microwave oven, is lustrous, and has a silver color with excellent coloration.

A ceramic product disclosed herein is a ceramic product including a decorative portion and the decorative portion includes a precious metal component, and has, in terms of a weight ratio where a total of a precious metal element included in the precious metal component is 100 wt %, a composition that includes 70 wt % to 100 wt % of Pt, and 0 wt % to 30 wt % of a total of Au, Rh, Pd, and Ag (where a content of Rh is 0 wt % to 10 wt % and a content of Au is 0 wt % to 18 wt %). Furthermore, a sheet resistance value of the decorative portion is 1×10⁸ Ω/sq. or more. Thus, a ceramic product including a decorative portion that does not spark when heated by a microwave oven, is lustrous, and has a silver color with excellent coloration is realized.

In a preferred mode of the ceramic product disclosed herein, the decorative portion has a film-like shape and an average film thickness is 20 nm or more and 300 nm or less. Thus, a decorative portion having a silver color with even better coloration is realized.

In another preferred mode of the ceramic product disclosed herein, an 8° gloss value of the decorative portion is 560 or more. Thus, a decorative portion that is particularly lustrous is realized.

It is preferable that the ceramic product disclosed herein serves as a tableware. The decorative portion does not spark when heated by a microwave oven, so that the ceramic product can serve as a tableware including a silver-colored decorative portion that can be heated by a microwave oven.

### BRIEF DESCRIPTION OF THE DRAWINGS

FIG. 1 is a cross-sectional FE-SEM image illustrating a cross section of a sintered film of a platinum solution of Example 14.

### DETAILED DESCRIPTION OF THE PREFERRED EMBODIMENTS

Preferred embodiments of the technology disclosed herein will be described below. Note that matters other than matters specifically mentioned in this specification and necessary for the implementation of the present invention (for example, a method for producing a ceramic substrate to which decoration is applied or the like) can be understood based on technical contents taught by the present specification and the common general technical knowledge of those skilled in the art. The technical contents disclosed herein can be implemented based on the contents disclosed in this specification and the common technical knowledge in the art. Note that, in this specification, the notation “A to B” indicating a numerical range means “A or more and B or less.” Accordingly, the numerical range encompasses a range that is more than A and less than B.

A platinum solution disclosed herein includes a metal element including a precious metal element. As the precious metal element, at least platinum (Pt) is included and, as a metal element other than Pt, at least bismuth (Bi) is included. In addition to the metal elements, at least silicon (Si) is included. Various components that the platinum solution disclosed herein can include will be described below.

In a sintered body (which will be hereinafter referred to as a “sintered film” or a “decorative portion”) of the platinum solution, a precious metal element is a component that contributes to a color of the sintered body. The platinum solution disclosed herein includes platinum (Pt) as a major precious metal element. The platinum solution may include gold (Au), rhodium (Rh), palladium (Pd), and silver (Ag). Moreover, the platinum solution can include ruthenium (Ru), iridium (Ir), and osmium (Os).

Platinum (Pt) is a silver-colored component with luster in the sintered body of the platinum solution. Pt is a major constituent component among precious metal elements included in a platinum solution (that is, a content Pt is 50 wt % or more of a total of the precious metal elements included in the platinum solution). Pt is a major constituent component of the platinum solution disclosed herein. Pt is included in the platinum solution, for example, as a constituent element of a Pt resinate. The Pt resinate has a property of forming Pt particles with a larger particle size than those of other precious metal elements by firing. Therefore, Pt particles have a property of being more difficult to be sintered than those of other precious metal elements. Thus, in the sintered body of the platinum solution, Pt particles tend to be arranged so as to be isolated from each other, so that electrical conductivity is reduced. As a result, the platinum solution disclosed herein can realize a sintered body that does not spark when heated by a microwave oven even in a case where a content of a component (for example, a glass component, such as Si, Bi, or the like) that reduces electrical conductivity in the sintered body is small.

In terms of a weight ratio where a total of metal elements included in the platinum solution and Si is 100 wt %, a ratio of Pt is 50 wt % or more, may be 60 wt % or more, and may be 70 wt % or more. Thus, a silver-colored sintered body that is lustrous and has excellent coloration is realized. On the other hand, when the ratio of Pt is too high, the number of Pt particles in the sintered body of the platinum solution is excessively large. Since the particle size of the Pt particles is large, an uneven state with a height difference occurs in a surface of the sintered body of the platinum solution and luster can be impaired. Therefore, in terms of the weight ratio described above, the ratio of Pt is appropriately 99 wt % or less, is preferably 98 wt % or less, is more preferably 90 wt % or less, and is further more preferably 85 wt % or less.

Gold (Au) is a component that adjusts hue of a silver color in the sintered body of the platinum solution. The platinum solution disclosed herein may include Au and may not include Au. When the platinum solution includes Au, in terms of a weight ratio where the total of the metal elements included in the platinum solution and Si is 100 wt %, a ratio of Au is, for example, 0.1 wt % or more, is preferably 3 wt % or more, and may be, for example, 4 wt % or more. Thus, a silver-colored sintered body that has excellent coloration can be realized. On the other hand, the ratio of Au is, for example, 20 wt % or less, may be 15 wt % or less, may be 10 wt % or less, and can be 8.5 wt % or less. According to the technology disclosed herein, even when the ratio of Au is in the above-described range, a silver-colored sinter body that has excellent coloration can be realized. Since Au is one of most expensive precious metals, costs can be controlled by preparing the platinum solution without Au therein or by keeping the ratio of Au in the above-described range.

Rhodium (Rh) is a component that can suppress increase in particle size of Pt particles generated by firing and increase the number of Pt particles having an appropriate particle size. Thus, a strength of the sintered boy is increased and coloration of the sintered body becomes excellent. The platinum solution disclosed herein may include Rh and may not include Rh. When the platinum solution includes Rh, in terms of a weight ratio where a total of metal elements included in the platinum solution and Si is 100 wt %, a ratio of Rh is, for example, 0.1 wt % or more and is preferably 0.4 wt % or more. On the other hand, when the ratio of Rh is too high, the particle size of the Pt particles can be excessively small. Thus, Pt particles are easily sintered, so that Pt tend to be continuously arranged in the sintered body and electrical conductivity can be increased. As a result, when the sintered body is heated by a microwave oven, not preferably, the sintered body is likely to spark. Therefore, the ratio of Rh is, for example, appropriately 8.5 wt % or less, may be 6 wt % or less, furthermore, may be 1.2 wt % or less, and may be 1 wt % or less.

Palladium (Pd) is a silver-colored component that can adjust hue of the sintered body of the platinum solution. The platinum solution disclosed herein may include Pd and may not include Pd. When the platinum solution includes Pd, in terms of a weight ratio where a total of metal elements included in the platinum solution and Si is 100 wt %, a ratio of Pd is, for example, 0.1 wt % or more and is preferably 1 wt % or more. Thus, excellent silver coloration of the sintered body of the platinum solution is achieved. Pd is more expensive than Pt, and therefore, from a viewpoint of cost cut, the ratio of Pd is, for example, preferably 10 wt % or less and is more preferably 8.5 wt % or less.

Silver (Ag) is a silver-colored component that can adjust the hue of the sintered body of the platinum solution. The platinum solution disclosed herein may include Ag and may not include Ag. When the platinum solution includes Ag, in terms of a weight ratio where a total of metal elements included in the platinum solution and Si is 100 wt %, a ratio of Ag is, for example, 0.1 wt % or more and may be 1 wt % or more. Ag has a property of being easy to be sulfurized, and therefore, when the ratio of Ag is high, the platinum solution can be blackened. Therefore, the ratio of Ag may be, for example, 10 wt % or less.

In terms of a weight ratio where a total of metal elements included in the platinum solution and Si is 100 wt %, a ratio of a precious metal element disclosed herein is preferably 70 wt % or more, is more preferably 75 wt % or more, and is further more preferably 80 wt % or more. Thus, a ratio of a precious metal component in the sintered body of the platinum solution becomes high, and excellent coloration of the sintered body can be achieved. Moreover, since the platinum solution disclosed herein includes Si and Bi, the ratio of the precious metal element is, for example, 99 wt % or less, may be 95 wt % or less, and may be 90 wt % or less.

Bismuth (Bi) is a component that increases an adhesive strength of the sintered body of the platinum solution and a ceramic substrate to which the sintered body is given (applied). Bi is a glass component that becomes an oxide after firing and can reduce electrical conductivity of the sintered body of the platinum solution. In terms of a weight ratio where a total of metal elements included in the platinum solution and Si is 100 wt %, a ratio of Bi included in the platinum solution disclosed herein is preferably 0.4 wt % or more and may be, for example, 1 wt % or more. When the ratio of Bi is in the above-described range, the electrical conductivity of the sintered body of the platinum solution can be preferably reduced and the adhesive strength of the sintered body and the ceramic substrate can be preferably increased. When the ratio of Bi is high, luster and coloration of the sintered body of the platinum solution can be impaired. Therefore, the ratio of Bi is, for example, 10 wt % or less and may be 8 wt % or less.

Silicon (Si) is a glass component that becomes an oxide after firing and can reduce the electrical conductivity of the sintered body of the platinum solution. Si can increase the strength of the sintered body. In terms of a weight ratio where a total of metal elements included in the platinum solution and Si is 100 wt %, a ratio of Si is preferably 0.5 wt % or more, may be 1 wt % or more, and may be 2 wt % or more. Thus, the electrical conductivity of the sintered body of the platinum can be preferably reduced. When the ratio of Si is high, the luster of the sintered body of the platinum solution can be impaired. Therefore, the ratio of Si may be, for example, 11 wt % or less and may be 10 wt % or less.

In the platinum solution disclosed herein, from a viewpoint of further reducing the electrical conductivity of the sintered body, in terms of the weight ratio, the ratio of Si included in the platinum solution is preferably higher than the ratio of Bi (Si>Bi). Si is a component that increases a softening point of glass formed after firing. Accordingly, when Si>Bi is satisfied, it is suppressed that the glass component is unevenly distributed at bottom of the precious metal particles due to gravity during firing of the platinum solution. As a result, the glass component is more reliably arranged between the precious metal particles in the sintered body of the platinum solution, so that the electrical conductivity can be further reduced.

Aluminum (Al) is a glass component that becomes an oxide after firing and can reduce the electrical conductivity of the sintered body of the platinum solution. Al can increase the strength of the sintered body. The platinum solution disclosed herein may include Al and may not include Al. When the platinum solution includes Al, with a large content of Al, the luster and coloration of the sintered body can be impaired. Therefore, in terms of a weight ratio where a total of metal elements included in the platinum solution and Si is 100 wt %, a ratio of Al is, for example, 5 wt % or less and may be approximately 4 wt % or less.

The platinum solution disclosed herein can include some other metal element than the above-described elements in a range in which technical effects disclosed herein are not impaired. Examples of other elements include, for example, zirconium (Zr), yttrium (Y), samarium (Sm), titanium (Ti), calcium (Ca), barium (Ba), chromium (Cr), tin (Sn), or the like. When the platinum solution includes some other metal, in terms of a weight ratio where a total of metal elements included in the platinum solution and Si is 100 wt %, a ratio of the other metals is typically 15 wt % or less, is preferably 10 wt % or less, and can be, for example, 5 wt % or less. The platinum solution may not include the other metals.

The metal elements and Si included in the platinum solution disclosed herein are included, for example, as resinates. As a metal resinate, in each metal element included in the platinum solution, one or two or more of organic metal compounds each including the metal element as a constitute element can be used without any particular limitation. Similarly, as a Si resinate, one or two or more of organic Si compounds each including Si as a constitute element can be used without any particular limitation. Examples of the organic compounds included in the organic metal compounds and the organic Si compound include, for example, carboxylic acids having a high carbon number (for example, eight or more carbon atoms), such as octylic acid (2-ethylhexanoic acid), abietic acid, naphthenic acid, stearic acid, oleic acid, linolenic acid, neodecanoic acid, or the like; sulfonic acid; resin acid included in rosin or the like; or resin sulfide balsam including an essential oil component, such as turpentine, lavender oil, or the like, alkyl mercaptide (alkyl thiolate), aryl mercaptide (aryl thiolate), mercaptocarboxylic acid ester, alkoxide, or the like.

The platinum solution disclosed herein preferably includes a solvent that disperses or dissolves the metal resinate and/or the Si resinate. As the solvent, a solvent used for a known resinate paste or a solvent used for liquid gold can be used without any particular limitation. For example, 1,4-dioxane, 1,8-cineole, 2-pyrrolidone, 2-phenylethanol, N-methyl-2-pyrrolidone, p-tolualdehyde, benzyl benzoate, butyl benzoate, eugenol, caprolactone, geraniol, methyl salicylate, cyclohexanone, cyclohexanol, cyclopentyl methyl ether, citronellal, di(2-chloroethyl) ether, diethylene glycol monomethyl ether, diethylene glycol monobutyl ether, dihydrocarbon, dibromomethane, dimethyl sulfoxide, dimethylformamide, nitrobenzene, pyrrolidone, propylene glycol phenyl ether, pulegone, benzyl acetate, benzaldehyde, turpentine, lavender oil, or the like. One or two or more solvents may be used. Note that such a resinate is commercially available as a resinate paste, and therefore, such a resinate paste may be used as it is.

As for a weight ratio of a solvent that can be included in the platinum solution, a preferable range differs depending on a method for applying the platinum solution, and there is no particular limitation on the weight ratio. Therefore, the weight ratio may be adjusted, as appropriate. For example, when the entire platinum solution is 100 wt %, the ratio of the solvent may be approximately about 10 wt % to 50 wt %. As an example, when the platinum solution is applied by inkjet, for example, the ratio of the solvent is preferably, for example, 10 wt % or 50 wt %. As another example, in a case of brush coating, for example, the ratio of the solvent is preferably, for example, 10 wt % to 30 wt %.

Viscosity of the platinum solution may be adjusted, as appropriate, depending on a method for applying the platinum solution and there is no particular limitation thereon. The viscosity of the platinum solution may be, for example, about 10 mPa·s to 500 mPa·s. Note that the viscosity of the platinum solution may be adjusted, as appropriate, in accordance with an amount of the solvent, by adding resin balsam, or the like.

Note that the platinum solution disclosed herein may additionally include some other component, as appropriate, unless the technical effects disclosed herein are remarkably impaired. Examples of an additional component include, for example, an organic binder, a protective material, a surfactant, a dispersant, a thickener, a pH regulator, a preservative, a defoaming agent, a plasticizer, a stabilizer, an antioxidant, or the like.

The platinum solution disclosed herein can be produced by mixing a material including a desired metal element and a material including Si at a predetermined ratio, for example, such that the platinum solution includes at least Pt, Si, and Bi. As the material including the metal element, typically, a metal resinate is used, but a metal complex or meal nanoparticles may be used as long as the technical effects disclosed herein are exhibited. As the material including Si, typically, a Si resinate is used, but the material may include a glass component, such as Si, Bi, or the like, as glass particles, as long as the technical effects disclosed herein are exhibited. A mixing method may follow a known method used for liquid gold for decoration and is not particularly limited. Also, a method for producing the platinum solution is not limited thereto.

The platinum solution disclosed herein can be used for applying decoration to a surface of a ceramic substrate as an article to be decorated. A decoration work can be performed by applying (imparting) the platinum solution to a surface of the ceramic substrate and then performing firing for decoration at a predetermined temperature. As one preferred example, the platinum solution disclosed herein is used for “overglazing” in which decoration is applied to the substrate after a glaze is applied to the substrate. In overglazing, after the platinum solution is applied to a surface of the glaze, firing for decoration may be performed at a medium temperature of about 700° C. to 1000° C. The platinum solution disclosed herein can be used also for “underglazing” in which decoration is applied to a bisque (ceramic substrate) that has undergone bisque-firing. In underglazing, after the platinum solution is applied to a bisque, firing for decoration may be performed, for example, at a high temperature of about 1200° C. to 1400° C. Note that examples of a method for applying the platinum solution include, for example, brush coating, screen printing, ink jet printing, or the like.

In a manner described above, a ceramic product including a silver-colored decorative portion that does not spark when heated by a microwave oven, is lustrous, and has excellent coloration can be achieved. Note that, as used herein, the term “ceramic product” encompasses pottery, porcelain, earthenware, stone tools, glass, or the like. Examples of a specific product include, for example, tableware, decorative tools, various tiles, sanitary ceramics, roof tiles, bricks, cray pipes, pottery pipes, or the like. In particular, according to the technology disclosed herein, a microwave-safe tableware including a silver-colored decorative portion is preferably realized.

A silver-colored decorative portion of a ceramic product obtained in the above-described manner is a sintered body of a platinum solution disclosed herein and includes at least Pt, Si, and Bi. The decorative portion is lustrous and has a silver color with excellent coloration. The decorative portion also has electrical insulation properties, so that generation of sparks by heating by a microwave oven is prevented. Furthermore, since the decorative portion has electrical insulation properties, temperature rise of the decorative portion can be suppressed, so that cracking in the decorative portion that can be caused by heating can be prevented. Note that, as used herein, the term “having electrical insulation properties” refers to a case where a sheet resistance value is 1×10⁸ Ω/sq. or more. The sheet resistance value can be measured, for example, by a four-probe method.

A precious metal component included in the decorative portion of the ceramic product disclosed herein is constituted of a precious metal element included in the platinum solution disclosed herein. That is, a ratio of the precious metal element in the platinum solution is reflected to a ratio of the precious metal element in the decorative portion. When a total of precious metal elements included in the precious metal component is 100 wt %, the decorative portion preferably has a composition that includes 70 wt % to 100 wt % of Pt, 0 wt % to 30 wt % of a total of Au, Rh, Pd, and Ag (where a content of Rh is 0 wt % to 10 wt % of Rh and a content of Au is 0 wt % to 18 wt %). Thus, a silver-colored decorative portion that is lustrous and has excellent coloration is realized. In the above-described configuration, even when the decorative portion does not include Au or includes Au at a low ration, that is, 18 wt % or less, the silver-colored decorative portion that has excellent coloration can be realized. Note that a constitution ratio of metal elements and Si included in the decorative portion may be a constitution ratio of the platinum solution used, but an inorganic component derived from the ceramic product (for example, derived from a glaze) may be mixed in.

A ratio of Pt in the decorative portion to a total of precious metal elements included in the decorative portion is approximately 70 wt % or more, is for example, 80 wt % or more, and may be 85 wt % or more. Moreover, the ratio of Pt may be 90 wt % or more and may be 95 wt % or more. Furthermore, the ratio of Pt may be 100 wt %. According to the technology disclosed herein, even when the ratio of Pt is in the above-described range, a decorative portion that does not spark when heated by a microwave oven, is lustrous, and has a silver color with excellent coloration is realized.

The decorative portion may not include each of Au, Rh, Pd, and Ag, and may include each of Au, Rh, Pd, and Ag. When the decorative portion includes each of these precious metal elements, a corresponding one of the ratios described above in the platinum solution disclosed herein is reflected thereto. Therefore, when the total of the precious metal elements is 100 wt %, the ratio of Au is, for example, 20 wt % or less, may be 18 wt % or less, may be 15 wt % or less, and may be 10 wt % or less. The ratio of Rh is, for example, 10 wt % or less, for example, may be 7 wt % or less, and may be 1.5 wt % or less. The ratio of Pd is, for example, 10 wt % or less and may be 7 wt % or less. The ratio of Ag may be, for example, 12 wt % or less. According to the technology disclosed herein, a decorative portion that is lustrous and has a silver color with excellent coloration is realized, even when the decorative portion does not include each of Au, Rh, Pd, and Ag or even when the decorative portion includes each of Au, Rh, Pd, and Ag at a low rate in the above-described range.

A color tone of the decorative portion of the ceramic product disclosed herein can be expressed by an L* value, an a* value, and a b* value in an L*a*b* table color system based on JIS Z8729 (2004). Note that the L* value, the a* value, and the b* value measured herein are values in a specular component included (SCI) mode for regular reflection light.

The L* value is an index representing brightness. An L* value of the decorative portion is preferably 60 or more and, for example, may be 61 or more, 62 or more, and 65 or more. Furthermore, the L* value of the decorative portion is more preferably 68 or more, is further more preferably 69 or more, and is particularly preferably 70 or more. Thus, a brighter color can be realized. On the other hand, when the L* value is too high, a color close to white is exhibited. Therefore, the L* value of the decorative portion is, for example, preferably 80 or less, is more preferably 78 or less, and may be, for example, 77 or less.

The a* value and the b* value are indexes representing chromaticity (hue and saturation). More specifically, +a* value represents a red direction and −a* value presents a green direction. +b* value represents a yellow direction and −b* value presents a blue direction. Therefore, in order for the decorative portion to have a silver color, it is preferable that the a* value and the b* value are not too high and not too low. The a* value is, for example, −20 or more and 20 or less, is preferably −10 or more and 10 or less, and is more preferably −5 or more and 5 or less. On the other hand, the b* value is, for example, −20 or more and 20 or less, may be −15 or more and 15 or less, and may be −10 or more and 10 or less.

A glossiness of the decorative portion can be represented by an 8° gloss value. As used herein, the term “8° gloss value” refers to a value obtained by measurement using a spectral colorimeter (for example, Spectrophotometer CM-600d, CM-700d manufactured by Konica Minolta Sensing, Inc., or the like) designed to approximate to a 60° glossmeter based on JIS Z8741 (1997). The lager the 8° gloss value is, the higher luster represented by the 8° gloss value becomes. The 8° gloss value of the decorative portion of the ceramic product disclosed herein is, for example, 550 or more, may be 560 or more, is preferably 600 or more, is more preferably 700 or more, is further more preferably 800 or more, and is particularly preferably 900 or more. According to the technology disclosed herein, a ceramic product including a decorative portion with high luster is realized.

The decorative portion is typically formed into a film-like shape on a surface of the ceramic substrate. There is no particular limitation on an average film thickness (thickness) of the decorative portion, but the average film thickness is preferably 20 nm or more and 300 nm or less and may be, for example, 20 nm or more and 200 nm or less. With the above-described average film thickness, reflected light on the surface of the decorative portion and reflected light on an interface between the decorative portion and the ceramic substrate interfere with each other, so that silver coloration becomes even better. Note that the average film thickness of the decorative portion can be adjusted, as appropriate, by an application method. For example, a decorative portion of a thin film having an average film thickness of about 20 nm and a decorative portion having a film thickness of 200 nm or more can be realized.

Test examples related to the technology disclosed herein will be described below, but it is not intended to limit the technology disclosed herein to the test examples.

### <Preparation of Platinum Solution>

Raw materials of metal elements and an Si element were mixed to achieve a composition (a ratio (wt %) of each element in terms of a weight) indicated in Table 1. Specifically, various raw materials were prepared in an ointment pot and were mixed for two minutes at a rotation speed of 1800 rpm using a stirrer manufactured by Thinky Co., Ltd. (product name: Rotation Revolution Mixer). Thus, platinum solutions of Examples 1 to 21 were prepared. In Table 2, a ratio (wt %) of each noble metal element to a total of noble metals in the platinum solution of each example is indicated. The raw materials of the metal elements and the Si element used in the examples are indicated below.
Pt: Pt resinate (platinum resin sulfide balsam)
Au: Au resinate (gold resin sulfide balsam)
Rh: Rh resinate (rhodium resin sulfide balsam)
Pd: Pd resinate (palladium resin sulfide balsam)
Ag: Ag resinate (silver resinate)
Si: Si resinate (silicon resinate)
Bi: Bi resinate (bismuth resinate)
Al: Al resinate (aluminum resinate) and aluminum complex
Zr: Zr resinate (zirconium resinate)
Y: Y resinate (yttrium resinate)
Sm: Sm resinate (samarium resinate)

TABLE 1

| | | | | | | | | | | | | | Precious |
|---|---|---|---|---|---|---|---|---|---|---|---|---|---|
| | | | | | | | | | | | | | metal |
| | | | | | | | | | | | | | element |
| | Composition (wt %) | | | | | | | | | | | | ratio |
| Sample | Pt | Au | Rh | Pd | Ag | Si | Bi | Al | Zr | Y | Sm | Ti | (wt %) |
| Example 1 | 100 | 0 | 0 | 0 | 0 | 0 | 0 | 0 | 0 | 0 | 0 | 0 | 100 |
| Example 2 | 68.6 | 0 | 0.4 | 0 | 0 | 16.2 | 14.8 | 0 | 0 | 0 | 0 | 0 | 69 |
| Example 3 | 75.3 | 0 | 9.9 | 0 | 0 | 6.5 | 5.9 | 0.1 | 0 | 2.3 | 0 | 0 | 85.2 |
| Example 4 | 82.6 | 0 | 0 | 0 | 0 | 9.8 | 7.6 | 0 | 0 | 0 | 0 | 0 | 82.6 |
| Example 5 | 76.6 | 8.5 | 0 | 0 | 0 | 8.4 | 6.5 | 0 | 0 | 0 | 0 | 0 | 85.1 |
| Example 6 | 68.1 | 8.5 | 0 | 8.5 | 0 | 8.4 | 6.5 | 0 | 0 | 0 | 0 | 0 | 85.1 |
| Example 7 | 59.6 | 8.5 | 8.5 | 8.5 | 0 | 8.4 | 6.5 | 0 | 0 | 0 | 0 | 0 | 85.1 |
| Example 8 | 78.9 | 4.1 | 0.5 | 0 | 0 | 9.3 | 7.2 | 0 | 0 | 0 | 0 | 0 | 83.5 |
| Example 9 | 78.2 | 4.1 | 1.2 | 0 | 0 | 9.3 | 7.2 | 0 | 0 | 0 | 0 | 0 | 83.5 |
| Example 10 | 74.8 | 3.9 | 5.6 | 0 | 0 | 8.9 | 6.8 | 0 | 0 | 0 | 0 | 0 | 84.3 |
| Example 11 | 77.8 | 4.1 | 0.6 | 1.2 | 0 | 9.2 | 7.1 | 0 | 0 | 0 | 0 | 0 | 83.7 |
| Example 12 | 74.3 | 3.9 | 0.6 | 5.6 | 0 | 8.8 | 6.8 | 0 | 0 | 0 | 0 | 0 | 84.4 |
| Example 13 | 94.3 | 0 | 0.7 | 0 | 0 | 2.2 | 2 | 0 | 0.8 | 0 | 0 | 0 | 95 |
| Example 14 | 71 | 3.7 | 0.4 | 0 | 0 | 11 | 9.9 | 0.1 | 3.9 | 0 | 0 | 0 | 75.1 |
| Example 15 | 75.3 | 0 | 0 | 0 | 9.9 | 6.5 | 5.9 | 0.1 | 0 | 2.3 | 0 | 0 | 85.2 |
| Example 16 | 86.4 | 0 | 0.5 | 0 | 0 | 1.4 | 5.3 | 3.2 | 0 | 0 | 3.3 | 0 | 86.9 |
| Example 17 | 69.2 | 17.3 | 0.5 | 0 | 0 | 1.4 | 5.3 | 3.2 | 0 | 0 | 3.3 | 0 | 87 |
| Example 18 | 97.9 | 0 | 0.6 | 0 | 0 | 0.5 | 0.4 | 0.3 | 0 | 0.3 | 0 | 0 | 98.5 |
| Example 19 | 83.7 | 0 | 0.5 | 0 | 0 | 6 | 5.4 | 0.1 | 2.1 | 2.3 | 0 | 0 | 84.2 |
| Example 20 | 79.5 | 0 | 0.5 | 0 | 0 | 6.1 | 5.6 | 0.1 | 0 | 0 | 7.5 | 0.7 | 80 |
| Example 21 | 75.4 | 0 | 0.5 | 0 | 0 | 4.6 | 5.3 | 0.1 | 0 | 0 | 14.2 | 0 | 75.9 |

TABLE 2

| | Ratio to total of precious metal elements (wt %) | | | | |
|---|---|---|---|---|---|
| Sample | Pt | Au | Rh | Pd | Ag |
| Example 1 | 100 | 0 | 0 | 0 | 0 |
| Example 2 | 99.4 | 0 | 0.6 | 0 | 0 |
| Example 3 | 88.4 | 0 | 11.6 | 0 | 0 |
| Example 4 | 100 | 0 | 0 | 0 | 0 |
| Example 5 | 90 | 10 | 0 | 0 | 0 |
| Example 6 | 80 | 10 | 0 | 10 | 0 |
| Example 7 | 70 | 10 | 10 | 10 | 0 |
| Example 8 | 94.5 | 4.9 | 0.6 | 0 | 0 |
| Example 9 | 93.7 | 4.9 | 1.4 | 0 | 0 |
| Example 10 | 88.7 | 4.6 | 6.7 | 0 | 0 |
| Example 11 | 93 | 4.9 | 0.7 | 1.4 | 0 |
| Example 12 | 88 | 4.6 | 0.7 | 6.7 | 0 |
| Example 13 | 99.3 | 0 | 0.7 | 0 | 0 |
| Example 14 | 94.6 | 4.9 | 0.5 | 0 | 0 |
| Example 15 | 88.4 | 0 | 0 | 0 | 11.6 |
| Example 16 | 99.4 | 0 | 0.6 | 0 | 0 |
| Example 17 | 79.5 | 19.9 | 0.6 | 0 | 0 |
| Example 18 | 99.4 | 0 | 0.6 | 0 | 0 |
| Example 19 | 99.4 | 0 | 0.6 | 0 | 0 |
| Example 20 | 99.4 | 0 | 0.6 | 0 | 0 |
| Example 21 | 99.3 | 0 | 0.7 | 0 | 0 |

### <Platinum Solution Film Coating and Firing>

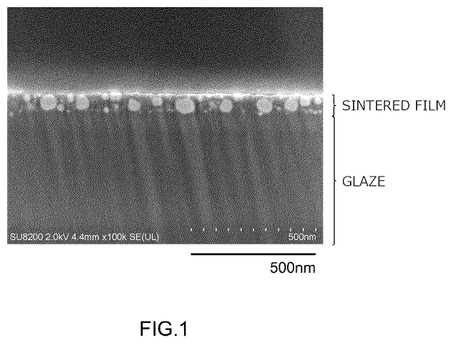

A white porcelain flat plate (length: 15 mm, width: 15 mm) having a surface with a glaze applied thereto was prepared and the prepared platinum solution was applied to an entire surface of one side of the white porcelain flat plate (film coating). For film coating, a spin coater: Opticoat MS-A-150 manufactured by Mikasa Co., Ltd was used, and spin condition was 5000 rpm for ten seconds. The film-coated white porcelain flat plate was dried on a hot plate at 60° C. for one hour, and then, was fired at 800° C. for ten minutes. Thus, white porcelain flat plates (Examples 1 to 21) each including a sintered body (which will be also referred to as a “sintered film” or a “decorative portion”) of a corresponding platinum solution were obtained. Note that it was confirmed that, by applying film coating under the above-described condition, a sintered film having a film thickness of about 20 nm to 200 nm could be obtained. The film thickness was confirmed by cross-section observation using FE-SEM (SU-8200 manufactured by Hitachi High-Tech Corporation). As a representing example, a cross-sectional FE-SEM image in a decorative portion of a white porcelain flat plate of Example 14 is illustrated in FIG. 1. Note that a white-colored portion in the sintered film in the cross-sectional FE-SEM image of FIG. 1 is a portion where precious metal particles exist.

### <Coloration Evaluation>

Using a spectral colorimeter, an L* value, an a* value, and a b* value and an 8° gloss value of the sintered body (decorative portion) of the platinum solution of the white porcelain flat plate in an SCI mode were measured. As the spectral colorimeter, a spectral colorimeter: CM-700d manufactured by Konica Minolta Sensing, Inc. was used. As a reference for coloration evaluation, for a case where the L* value was 60 or more and the 8° gloss value was 510 or more, “good” is indicated, and for a case where the L* value was less than 60 and/or the 8° gloss value was less than 510, “poor” is indicated. Results are given in Table 3.

### <Spark Test>

The obtained white porcelain flat plates (Examples 1 to 21) each including the sintered body of the corresponding platinum solution were heated by a microwave oven (output: 1000 W, electromagnetic wave: 2.45 GHZ) for 60 seconds. Thus, for a case where sparks were not generated, “good” is indicated, and for a case where sparks were generated, “poor” is indicated. Results are given in Table 3.

### <Electrical Conductivity Evaluation>

A sheet resistance value ((2/sq.) of each of the obtained white porcelain flat plates (Examples 1 to 21) each including the sintered body of the corresponding platinum solution was measured. Measurement of the sheet resistance value was performed by four-probe method using a resistivity meter: Loresta GP MCP-T610 manufactured by Mitsubishi Chemical Analytic Co., Ltd. Results are given in Table 3.

TABLE 3

| | Coloration | | | | | Sheet | |
|---|---|---|---|---|---|---|---|
| | L* | a* | b* | 8° | | resistance | Spark |
| Sample | value | value | value | gloss value | Evaluation | (Ω/sg.) | test |
| Example 1 | 68.5 | 0.28 | 4.25 | 505 | Poor | >1 × 10⁸ | Good |
| Example 2 | 66.3 | 1.03 | 7.72 | 485 | Poor | >1 × 10⁸ | Good |
| Example 3 | 55.1 | 2.71 | 11.2 | 464 | Poor | 3.6 × 10⁵ | Poor |
| Example 4 | 76.1 | 0.24 | 5.66 | 1008 | Good | >1 × 10⁸ | Good |
| Example 5 | 75.1 | 0.12 | 7.04 | 983 | Good | >1 × 10⁸ | Good |
| Example 6 | 74.4 | 0.17 | 9.73 | 973 | Good | >1 × 10⁸ | Good |
| Example 7 | 72.2 | 0.98 | 7.29 | 982 | Good | >1 × 10⁸ | Good |
| Example 8 | 74.1 | 0.55 | 13.3 | 988 | Good | >1 × 10⁸ | Good |
| Example 9 | 75.7 | 0.01 | 7.48 | 1016 | Good | >1 × 10⁸ | Good |
| Example 10 | 74.7 | 0.21 | 11.2 | 997 | Good | >1 × 10⁸ | Good |
| Example 11 | 75.9 | 0.01 | 6.9 | 1022 | Good | >1 × 10⁸ | Good |
| Example 12 | 75.3 | 0.06 | 9.46 | 1017 | Good | >1 × 10⁸ | Good |
| Example 13 | 68 | 0.3 | 7.89 | 703 | Good | >1 × 10⁸ | Good |
| Example 14 | 69.9 | 2.57 | 16.3 | 830 | Good | >1 × 10⁸ | Good |
| Example 15 | 75.5 | 0.38 | 7.35 | 940 | Good | >1 × 10⁸ | Good |
| Example 16 | 69.3 | 2.07 | 12.7 | 857 | Good | >1 × 10⁸ | Good |
| Example 17 | 69.5 | 3.59 | 13.9 | 849 | Good | >1 × 10⁸ | Good |
| Example 18 | 68.4 | 0.77 | 5.2 | 718 | Good | >1 × 10⁸ | Good |
| Example 19 | 61 | 7.45 | 17.2 | 564 | Good | >1 × 10⁸ | Good |
| Example 20 | 74.3 | 0.29 | 5.12 | 937 | Good | >1 × 10⁸ | Good |
| Example 21 | 60.3 | 4.03 | 9.89 | 579 | Good | >1 × 10⁸ | Good |

As indicated in Table 3, for Examples 1 to 3, the 8° gloss value was less than 510, and luster of the silver decorative portion was insufficient. In particular, for Example 3, the sheet resistance value was lower than those of the other examples and sparks were generated when heated by the microwave oven. On the other hand, for Examples 4 to 21, the 8° gloss value was 560 or more, the L* value was 60 or more, and a silver color with excellent coloration and luster was exhibited. For Examples 4 to 21, the sheet resistance value was more than 1×10⁸ Ω/sq. and sparks were not generated even when heated by the microwave oven. Based on the above-described evaluations, it is understood that silver decoration that does not cause sparks when heated by a microwave oven, gives luster, and allows excellent coloration can be realized by a platinum solution having a composition in which the ratio of Pt is 50 wt % to 99 wt %, the ratio of the total of Au, Rh, Pd, and Ag is 0 wt % to 25.5 wt % (where a content of Rh is 0 wt % to 8.5 wt %), the ratio of Si is 11 wt % or less, the ratio of Bi is 10 wt % or less, the ratio of Al is 0 wt % to 5 wt %, and the ratio of other metal elements is 0 wt % to 15 wt %.

Specific examples of the present invention have been described in detail above, but these are merely examples and do not limit the scope of the claims. The technology described in the scope of the claims includes various modifications and changes of the specific examples described above.

1. A platinum solution used for silver decoration of a ceramic substrate, the platinum solution comprising:
at least Pt, Si, and Bi,
wherein
in terms of a weight ratio where a total of a metal element included in the platinum solution and Si is 100 wt %,
the platinum solution has a composition that includes
50 wt % to 99 wt % of Pt,
0 wt % to 25.5 wt % of a total of Au, Rh, Pd, and Ag (where a content of Rh is 0 wt % to 8.5 wt %),
11 wt % or less of Si,
10 wt % or less of Bi,
0 wt % to 5 wt % of Al, and
0 wt % to 15 wt % of other metal elements.

2. The platinum solution according to claim 1,
wherein
in terms of the weight ratio, a ratio of the total of Pt, Au, Rh, Pd, and Ag is 70 wt % or more and 99 wt % or less.

3. The platinum solution according to claim 1,
wherein
in terms of the weight ratio, Si>Bi.

4. A ceramic product comprising:
a sintered body of the platinum solution according to claim 1.

5. A ceramic product comprising:
a decorative portion,
wherein
the decorative portion includes a precious metal component,
in terms of a weight ratio where a total of a precious metal element included in the precious metal component is 100 wt %,
the decorative portion has a composition that includes
70 wt % to 100 wt % of Pt, and
0 wt % to 30 wt % of a total of Au, Rh, Pd, and Ag (where a content of Rh is 0 wt % to 10 wt % and a content of Au is 0 wt % to 18 wt %), and
a sheet resistance value of the decorative portion is 1×10⁸ Ω/sq. or more.

6. The ceramic product according to claim 5,
wherein
the decorative portion has a film-like shape and an average film thickness is 20 nm or more and 300 nm or less.

7. The ceramic product according to claim 5,
wherein
an 8° gloss value of the decorative portion is 560 or more.

8. The ceramic product according to claim 5,
wherein
the ceramic product serves as a tableware.

9. The platinum solution according to claim 2,
wherein
in terms of the weight ratio, Si>Bi.

10. A ceramic product comprising:
a sintered body of the platinum solution according to claim 2.

11. A ceramic product comprising:
a sintered body of the platinum solution according to claim 3.

12. The ceramic product according to claim 6,
wherein
an 8° gloss value of the decorative portion is 560 or more.

13. The ceramic product according to claim 6,
wherein
the ceramic product serves as a tableware.

14. The ceramic product according to claim 7,
wherein
the ceramic product serves as a tableware.
